(19) United States
(12) Patent Application Publication
(10) Pub. No.: US 2012/0153210 A1
(43) Pub. Date: Jun. 21, 2012

(54) SILICONE STABILIZERS FOR RIGID POLYURETHANE OR POLYISOCYANURATE FOAMS

(75) Inventors: Martin Glos, Borken (DE); Carsten Schiller, Muelheim an der Ruhr (DE); Christian Eilbracht, Herne (DE)

(73) Assignee: EVONIK GOLDSCHMIDT GMBH, Essen (DE)

(21) Appl. No.: 13/325,812

(22) Filed: Dec. 14, 2011

(30) Foreign Application Priority Data
Dec. 16, 2010 (DE) DE102010063241.4

(51) Int. Cl. E04B 1/78; B05D 5/00; B29C 44/06; C07F 7/18

(52) U.S. Cl. 252/62; 556/445; 427/244; 264/45.1

(57) ABSTRACT

The invention provides partially endcapped polyether siloxanes, the use of these polyether siloxanes as foam stabilizers and also rigid polyurethane or polyisocyanurate foams obtained using the polyether siloxanes.

### FIELD OF THE INVENTION

The present invention relates to polyether siloxanes and their use as foam stabilizers in the production of polyurethane or polyisocyanurate foams, more particularly rigid foams, which offer advantageous performance characteristics, such as low thermal conductivity and good surface quality.

### BACKGROUND

Rigid polyurethane and polyisocyanurate foams are produced using cell-stabilizing additives to ensure a fine-celled, uniform and low-defect foam structure and hence to exert an essentially positive influence on the performance characteristics, particularly the thermal insulation performance, of the rigid foam. Surfactants based on polyether-modified siloxanes are particularly effective and therefore represent a preferred type of foam stabilizer.

Since there are a multiplicity of different rigid foam formulations for different fields of use where the foam stabilizer has to meet individual requirements, polyether siloxanes of varying structure are used. One of the selection criteria for the foam stabilizer is the blowing agent present in the rigid foam formulation.

There have already been various publications concerning polyether siloxane foam stabilizers for rigid foam applications. EP 0 570 174 B1 describes a polyether siloxane of the structure (CH₃)₃SiO[SiO(CH₃)₂]ₓ [SiO(CH₃)R]_{y}Si(CH₃)₃, the R radicals of which consist of a polyethylene oxide linked to the siloxane through an SiC bond and end-capped at the other end of the chain by a C₁-C₆ acyl group. This foam stabilizer is suitable for producing rigid polyurethane foams using organic blowing agents, particularly chlorofluorocarbons such as CFC-11.

The next generation are hydrochlorofluorocarbons such as, for example, HCFC-123. When these blowing agents are used for rigid polyurethane foam production, it is polyether siloxanes of the structural type (CH₃)₃SiO[SiO(CH₃)₂]ₓ[SiO(CH₃)R]_{y}Si(CH₃)₃ which are suitable according to EP 0 533 202 A1. The R radicals in this case consist of SiC-bonded polyalkylene oxides which are assembled from propylene oxide and ethylene oxide and can have a hydroxyl, methoxy or acyloxy function at the end of the chain. The minimum proportion of ethylene oxide in the polyether is 25 per cent by mass.

EP 0 877 045 B1 describes analogous structures for this production process which differ from the first-named foam stabilizers in that they have a comparatively higher molecular weight and have a combination of two polyether substituents on the siloxane chain.

The production of rigid polyurethane foams using purely hydrofluorocarbons, e.g., Freon, as a blowing agent may, according to EP 0 293 125 B1, also utilize mixtures of different stabilizers, for example, the combination of a purely organic (silicon-free) surfactant with a polyether siloxane.

A more recent development in the production of rigid polyurethane foams is to dispense with halogenated hydrocarbons as blowing agents entirely and to use hydrocarbons such as pentane instead. EP 1 544 235 describes the production of rigid polyurethane foams using hydrocarbon blowing agents and polyether siloxanes of the already known structure (CH₃)₃SiO[SiO(CH₃)₂]ₓ[SiO(CH₃)R]_{y}Si(CH₃)₃ having a minimum chain length for the siloxane of 60 monomer units and different polyether substituents R, the mixed molecular weight of which is in the range from 450 to 1000 g/mol and the ethylene oxide fraction of which is in the range from 70 to 100 mol %.

DE 10 2006 030 531 describes polyether siloxanes, as foam stabilizers, in which the end group of the polyethers is either a free OH group or an alkyl ether group (preferably methyl) or an ester. Particular preference is given to using such polyether siloxanes which have free OH functions.

EP 0254890 describes the use of polyether siloxanes for producing high resiliency molded foam wherein the siloxane contains not more than 10 silicon atoms and the end groups of the polyethers preferably bear mixed OH functions and alkoxy functions. No rigid foam applications are described in EP 0254890.

U.S. Pat. No. 4,014,825 describes organomodified siloxanes for polyurethane foam production which, in addition to alkyl and polyether substituents, also bear side chains having tertiary OH groups. Thus, additional substituents are introduced in the '825 patent. The polyethers used in the '825 patent are usually methyl endblocked.

Yet the foam stabilizers described in the aforementioned publications do not cover the whole spectrum of the various rigid foam formulations, and there are many fields where improvements in foam stabilizers over the prior art are desirable in order to further optimize the performance characteristics of rigid foams, particularly in respect of thermal conductivity and foam defects at the surface.

The object of providing alternative foam stabilizers which do not have one or more of the disadvantages known from the prior art therefore continues to exist.

### SUMMARY OF THE INVENTION

In one embodiment, the present invention provides alternative foam stabilizers which are an improvement over prior art stabilizers.

In another embodiment, the present invention also provides rigid polyurethane or polyisocyanurate foams and their underlying formulations that offer advantageous performance characteristics, for example, low thermal conductivity and/or good surface quality.

The applicants of the present invention have surprisingly found that polyether siloxanes of formula (I), as described hereinbelow, where 10 to 90 mol % of the polyether residues are capped with an alkyl radical or carbonyl radical, or bear no OH function, can achieve one or more of the aforementioned embodiments.

The present invention accordingly provides polyether siloxanes of formula (I), as described hereinbelow, where 10 to 90 mol % of polyether residues are capped with an alkyl radical (or acetyl radical), and also mixtures thereof, and the use of the inventive polyether siloxanes for producing polyurethane foams or polyisocyanurate foams.

The present invention further provides a composition suitable for producing rigid polyurethane or polyisocyanurate foams, containing at least one isocyanate component, at least one polyol component, at least one foam stabilizer, at least one urethane and/or isocyanurate catalyst, water and/or blowing agent, and optionally at least one flame retardant and/or further additives, characterized in that at least one polyether siloxane according to the invention is present as the foam stabilizer, a process for producing rigid polyurethane or polyisocyanurate foams, by reacting this composition, and also the rigid polyurethane or polyisocyanurate foams obtainable thereby.

The present invention additionally provides for the use of rigid polyurethane or polyisocyanurate foams according to the invention as insulation boards and insulants, and also a cooling apparatus which includes a rigid polyurethane or polyisocyanurate foam according to the invention as an insulating material.

The polyether siloxanes according to the invention have the advantage of providing polyurethane or polyisocyanurate foams, more particularly rigid foams, which have a good fine-cell content and good insulating properties and at the same time have little by way of foam defects.

The polyether siloxanes according to the present invention also ameliorate the number of foam defects at or below the surface of the foam, compared with analogous polyether siloxanes without controlled adjustment of the end group functionality of the polyethers. The avoidance of such surface defects improves the performance characteristics of the end product, for example, the energy efficiency of a refrigerator or the insulating properties of an insulating panel. Particularly the sector of panel manufacture utilizes very different materials as “coating” which can each be flexible, ductile or else hard and brittle. The materials range from various paper grades, through plastics films, metal foils (aluminium foils), and various composite foils through metal surfacing layers composed of steel, which must be mechanically preshaped in advance, to wood or gypsum boards which are no longer formable.

Using the polyether siloxanes of the present invention results in fewer surface defects observed on the different foamed materials than in the case of polyether siloxanes according to the prior art.

### BRIEF DESCRIPTION OF THE DRAWINGS

FIG. 1 is a photo of a foam surface after removal of an approximately 5×20 cm piece of steel sheet from a foam produced pursuant to comparative example 3 of the present disclosure.

FIG. 2 is a photo of a foam surface after removal of an approximately 5×20 cm piece of steel sheet from a foam produced pursuant to comparative example 4 of the present disclosure.

FIG. 3 is a photo of a foam surface after removal of an approximately 5×20 cm piece of steel sheet from a foam produced pursuant to test 10.

FIG. 4 is a photo of a foam surface after removal of an approximately 5×20 cm piece of steel sheet from a foam produced pursuant to test 11.

FIG. 5 is a photo of a foam surface after removal of an approximately 5×20 cm piece of steel sheet from a foam produced pursuant to test 12.

FIG. 6 is a photo of a foam surface after removal of an approximately 5×20 cm piece of steel sheet from a foam produced pursuant to test 13.

FIG. 7 is a photo of a foam surface after removal of an approximately 5×20 cm piece of steel sheet from a foam produced pursuant to test 14.

### DETAILED DESCRIPTION

The inventive polyether siloxanes, compositions and polyurethane foams and also uses thereof will now be described by way of example without any intention to restrict the invention to these exemplary embodiments. Where ranges, general formulae or classes of compounds are indicated in what follows, they shall encompass not just the corresponding ranges or groups of compounds that are explicitly mentioned, but also all sub-ranges and sub-groups of compounds which are obtainable by extraction of individual values (ranges) or compounds. Where documents are cited in the context of the present description, their content shall fully belong to the disclosure content of the present invention particularly in respect of the factual position in the context of which the document was cited. Average values indicated in what follows are number averages, unless otherwise stated.

As stated above, the present invention provides polyether siloxanes of formula (I),

R—Si(CH₃)₂—O—[—Si(CH₃)₂—O—]ₙ—[—Si(CH₃)R¹—O—]ₘ—Si(CH₃)₂—R²

where
R, R¹ and R² are the same or different,
R and/or R² are methyl or R¹,
R¹ in each occurrence is the same or different and represents —(CH₂)ₓ—(O)_{z}—(CH₂—CHR′—O)_{y}—R″,
R′ in each occurrence is the same or different and represents —H, —CH₃, —CH₂CH₃ or phenyl,
R″ in each occurrence is the same or different and represents —H, —(CO)—R′″, —(CO)—NH—R′″or -alkyl, preferably C₁ to C₄₀-alkyl, more preferably C₁- or C₆ to C₃₀-alkyl,
R′″ in each occurrence is the same or different and represents C₁ to C₄₀-alkyl, -aryl or -alkylaryl,
n+m+2=10 to 150, preferably 12 to 85, more preferably 15 to 47,
m=0 to 20, preferably 1 to 4,
x=2 to 15, preferably 3 to 10,
y=1 to 40, preferably 2 to 19,
z=0 or 1
where the (CH₂—CHR′—O) units can be the same or different,
with the proviso that for m=0 at least one R or R² radical is R¹,
and that for z=0 the requirement is that x and y=0 and R″ contains at least 3 carbon atoms, although z=0 applies to not more than 70 mol %, preferably 50 mol % of the R¹ radicals in the siloxane,
or a mixture thereof,
characterized in that on average (number average, averaged over all compounds of formula (I)) from 10 to 90 mol %, preferably 25 to 75 mol %, more preferably 40 to 60 mol % and even more preferably 45 to 55 mol % of the R″ radicals are not hydrogen radicals, but preferably —(CO)—R′″, —(CO)—NH—R′″ or -alkyl, preferably C₁ to C₄₀-alkyl radicals and more preferably exclusively methyl radicals, and the remaining proportions of the R″ radicals are hydrogen atoms.

The degree of endcapping (proportion of R″ radicals other than hydrogen) can be set via the polyethers used in the preparation or via the amount of capping reagent used. The degree of endcapping can further be determined using NMR methods. Preferably, the determination is effected as hereinbelow described using an NMR spectrometer with a processor unit and autosampler with 5 mm sample head from Bruker, type 400 MHz, 10 mm QNP using 5 mm sample tubes and closure caps made of plastic, both from Norell Inc. Sampling is done using Pasteur pipettes from Brand. Reagents used are: deuterochloroform (CDCl₃) from Deutro, degree of deuterization 99.8%), A3 molecular sieve from Merck (to remove water residues from the solvent).

The measurements are carried out using the measurement parameters reported in Table A:

TABLE A
Measurement parameters for NMR measurements

| | |
|---|---|
| ¹H NMR | ¹³C NMR |

| | | | | |
|---|---|---|---|---|
| sample quantity | about 20 | mg | about 1 | g |
| CDCl₃ volume | about 1.25 | ml | about 5 | ml |
| transmitter frequency | 399.87 | MHz | 100.565 | MHz |

| | | |
|---|---|---|
| Pulse | 8 | 10 |

| | | | | |
|---|---|---|---|---|
| relaxation time | 0 | sec | 10 | sec |
| transmitter offset | 1350.0 | Hz | 11 000 | Hz |

| | | |
|---|---|---|
| measuring time | 16 | 512 |

| | | | | |
|---|---|---|---|---|
| line width | 0.1 | Hz | 1 | Hz |

The stated sample quantity is introduced into a clean NMR tube and admixed with the stated volume of CDCl₃. The sample tube is sealed with the plastic cap and the sample is homogenized by shaking. After all the air bubbles have risen to the surface, the sample is measured in the NMR spectrometer. Assigning the individual signals is familiar to a person skilled in the art, or can optionally be done by comparison with the signals of suitable example substances. Evaluation in respect of the molar ratios of free OH groups (R″═H) to endcapped OH groups (R″ other than H) is done by forming the ratios of the corresponding integrals of the signals assigned to the respective groups. To ensure comparability of the signals, a person skilled in the art will be familiar with adding so-called accelerators to the samples. A suitable accelerator can be determined by a person skilled in the art by measuring model substances for which the molar ratio is known. Suitable accelerators are those wherein the measured ratio does not differ from the actual ratio by more than 5%. An example of an accelerator which can be used is chromium acetylacetonate, which is added in concentrations of about 0.8% by mass based on the sample quantity.

It is essential for the polyether siloxanes of the present invention that the polyether substituents be situated in a comb (lateral) position of the siloxane chain. In addition, polyether substituents can be present on the terminal silicon atoms of the siloxane chain.

The inventive polyether siloxanes of formula (I) are copolymers which, by the nature of their method of making, are usually polydisperse compounds, so that only averages can be indicated for the parameters n, m and y in particular. Similarly, the alkyl radicals for R″ and R′″ may, as the case may be, not be unitary compounds, but again a mixture of different chain lengths as can arise in the production of olefins or carboxylic acids.

In preferred polyether siloxanes according to the present invention, on average (number average, averaged over all compounds of formula (I)) at least 50 mol % of the R′ radicals are —H.

In particularly preferred polyether siloxanes, the quotient Q=(n+m)/m is not less than 5, preferably not less than 7, more preferably not less than 9 and even more preferably not less than 11.

Preference is further given to polyether siloxanes wherein at least one R or R² radical is R¹. On average it is preferably at least 75 mol %, more preferably 90 mol % and even more preferably 100 mol % of the R and R² radicals which are R′. In one particularly preferred polyether siloxanes or mixtures thereof, at least one R or R² radical is R′, preferably on average at least 75 mol %, more preferably 90 mol % and even more preferably 100 mol % of the R and R² radicals are R¹ and the quotient Q is above 7, preferably greater than 9 and more preferably above 11.

In particularly preferred polyether siloxanes of a further embodiment, on average m is 0 to 5, n+m+2 is 10 to 40, x is 3 and y is 5 to 25.

The alkylene oxide units bearing the index y may be ethylene oxide, optionally propylene oxide, optionally butylene oxide, and/or optionally styrene oxide in any sequence, the amount of substance proportion attributable to ethylene oxide being preferably at least 50 mol % and more preferably at least 90 mol %.

The polyether residues (R¹) in any one molecule can be identical to or different from each other, provided all the components of the polyether mixture satisfy the above definition. Mixtures of various polyether siloxanes are also included, provided that either the average values of the mixture come within the abovementioned ranges or a component conforms to the above definition.

The customary process for preparing the polyether siloxane foam stabilizers of the present invention consists in the transition metal-catalysed hydrosilylation of the olefinically unsaturated polyethers with SiH-functional siloxanes, and is known prior art. The preparation of Si—C-linked polyether siloxanes is described for example in EP 1439200, EP 1544235, U.S. Pat. No. 4,147,847, U.S. Pat. No. 4,025,456, EP 0493836 and U.S. Pat. No. 4,855,379. A hydrosilylation process is described in EP 1 520 870 and documents cited therein.

The siloxanes of the present invention can in principle be prepared by the known prior art, for example, as in the documents mentioned hereinbelow. EP 0 493 836 describes the preparation of polyether-modified siloxanes used in flexible foams. Further examples relating to the preparation of appropriate siloxanes are described for example in U.S. Pat. No. 4,147,847 and U.S. Pat. No. 4,855,379.

The allyl polyethers used can likewise be prepared according to the known prior art. For instance, EP 1 360 223 and the documents cited therein describe the preparation of olefinic polyethers with and without derivatization of the OH functionality. U.S. Pat. No. 5,877,268 and (U.S. Pat. No. 5,856,369) describe(s) the preparation of allyl-started polyethers using DMC catalysis.

DE 19940797 describes the preparation and use of polyalkylene oxides using potassium methoxide as a catalyst.

U.S. Pat. No. 3,957,843 (and U.S. Pat. No. 4,059,605) describe(s) in Examples 1 and 2 the preparation of polyethers where R″=methyl and R″=hydrogen.

U.S. Pat. No. 3,507,923 describes a process for preparing methylated allyl-started polyethers using methyl chloride.

DE 102005001076 describes an industrial process for producing methylated polyethers.

DE 3121929 describes the preparation of methyl allyl polyethers from methanol-started polyethers by reaction with allyl chloride.

EP 1927613 describes a process for etherifying the free OH functionality of polyethers using Williamson's ether synthesis. Example 2 describes the methylation of an allyl-started polyether.

To prepare polyether siloxanes of the present invention wherein the proportion of R″ radicals in the polyether side chains is or is not hydrogen, there are several possibilities.

One possibility is to use several (different) polyethers having corresponding end groups in the hydrosilylation reaction. Alternatively, one or more polyethers bearing OH functions can be partially “endcapped” through appropriate derivatization. The OH function can be derivatized by etherification, esterification, etc., but only carried out incompletely in order thereby to arrive at polyethers which can serve as a basis for the polyether siloxanes of the present invention.

A further possible synthesis consists in performing the derivatization as a last step in the preparation of the polyether siloxanes. In this case, polyether siloxanes bearing radicals of the type R″=hydrogen are subjected to an appropriate derivatization.

Combinations of the various methods of preparation are likewise possible.

The polyether siloxanes according to the invention can be used in all known applications where polyether siloxanes are used as stabilizers. Preferably, the polyether siloxanes according to the invention are used for producing polyurethane foams and polyisocyanurate foams, more particularly for producing rigid polyurethane or polyisocyanurate foams.

The compositions according to the invention which are suitable for producing rigid polyurethane or polyisocyanurate foams contain at least one isocyanate component, at least one polyol component, at least one foam stabilizer, at least one urethane and/or isocyanurate catalyst, water and/or blowing agents, and optionally at least one flame retardant and/or further additives, and wherein at least one of the foam stabilizers is at least one inventive polyether siloxane or a polyether siloxane mixture which includes or consists of polyether siloxanes according to the invention.

In the composition according to the invention, the mass fraction attributable to inventive polyether siloxane (as foam stabilizers) based on 100 parts by mass of polyol component (pphp) is preferably in the range from 0.1 to 10 pphp, more preferably in the range from 0.5 to 5 pphp and even more preferably in the range from 1 to 3 pphp.

Suitable water contents for the purposes of this invention depend on whether or not one or more blowing agents are used in addition to the water. In the case of purely water-blown foams, the values are typically in the range from 1 to 20 pphp, but when other blowing agents are used in addition, the amount of water used typically reduces to the range from 0.1 to 5 pphp.

When additional blowing agents are present in the composition according to the invention, these can be physical or chemical blowing agents. The composition preferably includes physical blowing agents. Suitable physical blowing agents for the purposes of this invention are gases, for example, liquefied CO₂, and volatile liquids, for example, hydrocarbons having 4 to 5 carbon atoms, preferably cyclopentane, isopentane and n-pentane, hydrofluorocarbons, preferably HFC 245fa, HFC 134a and HFC 365mfc, hydrochlorofluorocarbons, preferably HCFC 141b, oxygen-containing compounds such as methyl formate and dimethoxymethane, or chlorinated hydrocarbons, preferably 1,2-dichloroethane.

In addition to or in lieu of water and any physical blowing agents, it is also possible to use other chemical blowing agents which react with isocyanates to evolve a gas, an example being formic acid.

By way of flame retardants, the composition according to the invention may include any known flame retardants suitable for producing rigid polyurethane or polyisocyanurate foams. Suitable flame retardants for the purposes of this invention are preferably liquid organic phosphorus compounds, such as halogen-free organic phosphates, e.g., triethyl phosphate (TEP), halogenated phosphates, e.g. tris(1-chloro-2-propyl) phosphate (TCPP) and tris(2-chloroethyl) phosphate (TCEP) and organic phosphonates, e.g., dimethyl methanephosphonate (DMMP), dimethyl propanephosphonate (DMPP), or solids such as ammonium polyphosphate (APP) and red phosphorus. Suitable flame retardants further include halogenated compounds, for example, halogenated polyols, and also solids, such as expandable graphite and melamine.

By way of isocyanate component, the composition according to the invention can include any isocyanate compounds suitable for producing rigid polyurethane or polyisocyanurate foams. Preferably, the composition according to the invention includes one or more organic isocyanates having two or more isocyanate functions suitable isocyanates for the purposes of this invention include any multifunctional organic isocyanates, for example, 4,4′-diphenylmethane diisocyanate (MDI), toluene diisocyanate (TDI), hexamethylene diisocyanate (HMDI) and isophorone diisocyanate (IPDI). What is particularly suitable is the mixture of MDI and more highly condensed analogues having an average functionality in the range from 2 to 4 which is known as “polymeric MDI” (“crude MDI”). Examples of particularly suitable isocyanates are mentioned for example in EP 1 712 578, EP 1 161 474, WO 00/58383, U.S. Patent Application Publication No. 2007/0072951, EP 1 678 232 and WO 2005/085310.

Suitable polyols for the purposes of this invention include any organic substances having two or more isocyanate-reactive groups, and also preparations thereof. Any polyether polyols and polyester polyols customarily used for producing rigid foams are preferred polyols. Polyether polyols are obtainable by reacting polyfunctional alcohols or amines with alkylene oxides. Polyester polyols are based on esters of polybasic carboxylic acids (which are usually phthalic acid or terephthalic acid) with polyhydric alcohols (usually glycols).

Depending on the properties required of the resulting foams, corresponding polyols can be used, as described for example in: U.S. Patent Application Publication No. 2007/0072951 A1, WO 2007/111828, U.S. Patent Application Publication No. 2007/0238800, U.S. Pat. No. 6,359,022 or WO 96/12759.

Polyols based on vegetable oil can also be used. Such polyols are described, for, example in WO 2006/094227, WO 2004/096882, U.S. Patent Application Publication No. 2002/0103091, WO 2006/116456 and EP 1 678 232.

The ratio of isocyanate to polyol, expressed as the index, in the composition of the present invention is preferably in the range from 80 to 500 and more preferably in the range from 100 to 350. The index describes the ratio of isocyanate actually used to isocyanate computed (for a stoichiometric reaction with polyol). An index of 100 represents a molar ratio of 1:1 for the reactive groups.

The index governs what happens chemically in the foaming operation. With a high index, i.e., a high excess of isocyanate, it is not just the polyurethane reaction which occurs, between isocyanate and polyol, but also the formation of polyisocyanurate due to isocyanate functions reacting with each other. Therefore, mixtures having a comparatively high index are known as polyisocyanurate formulations (PIR) and mixtures having a comparatively low index as polyurethane formulations (PUR). There is no clear cut transition , so the definition of PUR and PIR is also not unambiguously defined. The boundary region occurs at index numbers in the range from 150 to 200. Formulations having these index numbers are also known as hybrid systems.

The polyether siloxanes of the present invention, and mixtures thereof, can be used as additives in both (or all three) formulations.

By way of urethane and/or isocyanurate catalysts, the composition according to the present invention includes one or more catalysts for the reactions of isocyanate-polyol and/or isocyanate-water and/or isocyanate trimerization. Suitable catalysts for the purposes of this invention are substances catalyzing the gel reaction (isocyanate-polyol), the blowing reaction (isocyanate-water) and/or the di- or trimerization of the isocyanate. Typical examples are the amines triethylamine, dimethylcyclohexylamine, tetramethylethylenediamine, tetramethylhexanediamine, pentamethyldiethylenetriamine, pentamethyldipropylenetriamine, triethylenediamine, dimethylpiperazine, 1,2-dimethylimidazole, N-ethylmorpholine, tris(dimethylaminopropyl)hexahydro-1,3,5-triazine, dimethylaminoethanol, dimethylamino-ethoxyethanol and bis(dimethylaminoethyl) ether, tin compounds such as dibutyltin dilaurate and potassium salts such as potassium acetate and potassium 2-ethylhexanoate. Suitable catalysts are mentioned for example in EP 1985642, EP 1985644, EP 1977825, U.S. Patent Application Publication No. 2008/0234402, EP 0656382 B1 and U.S. Patent Application Publication No. 2007/0282026 and the patent documents cited therein.

Preferred amounts of catalysts present in the composition according to the invention depend on the type of catalyst and are typically in the range from 0.05 to 5 pphp (=parts by mass per 100 parts by mass of polyol) or from 0.1 to 10 pphp for potassium salts.

A comprehensive review of the prior art, of the raw materials used and of processes which can be used is found in G. Oertel (ed.): “Kunststoffhandbuch”, volume VII, C. Hanser Verlag, Munich, 1983, in Houben-Weyl: “Methoden der organischen Chemie”, volume E20, Thieme Verlag, Stuttgart 1987,(3), pages 1561 to 1757, and in “Ullmann's Encyclopedia of Industrial Chemistry”, vol. A21, VCH, Weinheim, 4th edition 1992, pages 665 to 715.

The inventive process for producing rigid polyurethane or polyisocyanurate foams includes that an inventive composition as described above is reacted. The production of rigid polyurethane or polyisocyanurate foams or the reaction of corresponding compositions can be carried out according to the known methods. Continuous or batch operations may be concerned for example, or high pressure or low pressure machines can be used.

A preferred rigid polyurethane or polyisocyanurate foam formulation for the purposes of this invention would produce a foam density of 20 to 50 kg/m³ and would have the following composition:

TABLE 1

| Component | Weight fraction |
|---|---|
| Polyol | 100 |
| amine catalyst | 0.05 to 5 |
| potassium trimerization catalyst | 0 to 10 |
| polyether siloxane of formula (I) | 0.5 to 5 |
| Water | 0.1 to 20 |
| blowing agent | 0 to 40 |
| flame retardant | 0 to 50 |

isocyanate index: 80 to 500

The processing of the composition according to the present invention to form rigid foams can be carried out according to any method known to a person skilled in the art, for example, by manual mixing or preferably by means of high pressure foaming machines. In the case of metal composite elements, manufacture can be not only batchwise but also continuous in the so-called double band process.

The rigid polyurethane or polyisocyanurate foams according to the invention are obtainable by the process according to the invention. The proportion of polyether siloxane according to the invention present in bound and/or unbound form in the rigid polyurethane or polyisocyanurate foams according to the invention is preferably in the range from 0.1 to 10 parts by mass, more preferably in the range from 0.5 to 5 parts by mass and even more preferably in the range from 1 to 3 parts by mass based on 100 parts by mass of polyol component.

The rigid polyurethane or polyisocyanurate foams according to the invention can be used as or for producing insulation boards and insulants or insulating materials. This provides cooling apparatuses, for example refrigerators or freezer chests, marked by including a rigid polyurethane or polyisocyanurate foam according to the invention as insulating material.

A further important field of use for rigid polyurethane or polyisocyanurate foams is that of insulation boards with flexible surfacing layers (such as aluminium-coated paper for example) which are used for thermal insulation in the construction of houses and buildings. In addition, there are also composite elements consisting of a rigid foam core and solid metallic surfacing layers (sheet steel for example), which are likewise used as construction elements in the building sector.

Some particularly preferred applications will now be described without any intention to restrict the subject matter of the invention to them.

A preferred embodiment of the present invention employs the compositions according to the invention as PUR formulations (index below 200) which are to be used in foaming in a batch operation in a mold. These molds are often dimensioned such that the foaming mixture has long flow paths and thereby the susceptibility to foam disruptions increases. The use of the compositions according to the invention can minimize the susceptibility to foam disruptions.

The compositions according to the invention are preferably employed in the production of refrigerators or other cooling assemblies. This involves a batch operation in which the foaming mixture is injected into the so-called cabinet and has to fill out the available space there. The foam is subjected to a flow stress, increasing the danger of defect formation. In addition, the materials used play an important part. The inliner usually consists of plastics material and the outer shell of the refrigerator usually consists of a metal surfacing layer. There must be no foam defects arising out of the interaction with these materials or any contamination present thereon. The compositions according to the present invention display a superior ability to prevent foam defects arising under these conditions. As a result, even thin surfacing layers, for example metal surfacing layers and/or plastics surfacing layers, will provide a smooth surface to the refrigerator, since the propensity to defect formation at the boundary layer is suppressed. The plastics surfacing layers can be for example polypropylene, polyethylene or high impact polystyrene (HIPS) surfacing layers.

In a further preferred embodiment of the present invention, the compositions according to the invention are employed in the production of composite elements. In this embodiment, a batch operation is used to inject the foaming composition between two surfacing layers. PUR and PIR recipes can both be used here. Various materials are possible for use as surfacing layers. It is usually metal surfacing layers which are used for producing metal composite elements which are then used in the building construction industry. However, plastics surfacing layers can also be used on one or both of the sides. The composite elements thus obtained, often also referred to as panels, can find use in various sectors such as the building construction industry (exteriors), in the automotive sector (caravan sector), the exposition industry (lightweight walls) or furniture production. Particularly when plastics surfacing layers are used on both sides, very lightweight composite elements can be produced. The following materials can be used as surfacing layers, for example: PMMA (polymethyl methacrylate), HIPS (high impact polystyrene), PP (polypropylene), Resopal, fibre-reinforced paper types. Particular problems can arise with coatings on the metal surfacing layers or processing aids (release agents) on plastics surfaces, which can be disadvantageous for the formation of the foam. In general, the compositions according to the invention exhibit advantages in relation to surface qualities, since fewer foam defects arise than with the use of prior art siloxanes. In addition to the aesthetic aspects, the adherence of the surfacing layers to the foam can also be improved.

In a further preferred embodiment, the compositions according to the invention (or the polyether siloxanes according to the invention) are used in the continuous production of polyurethane- or polyisocyanurate-based metal panels. In this process, the foaming mixture is applied via a traversing mix head to the lower metal layer in a double band laminator at band speeds of not more than 25 m/min Often, the metal surfacing layers are profiled. In the laminator, the rising mixture then reaches the upper surfacing layer to produce a continuously formed metal panel which is cut into the desired length at the exit end of the laminator.

In some embodiments, the foaming mixture has to completely cover the often profiled surfacing layers and completely fill the space between the surfacing layers. In most cases, the foaming mixture is metered from a mix head on which a so-called casting rake can be situated. A casting rake discharges the mixture from a plurality of openings along the band direction. To obtain a uniform distribution of foam across the width of the panel, the mix head is moved traversingly across the width of the panel. A further objective is the avoidance of surface defects which can be due to coatings on the metal surfacing layers (coil coatings), since these often contain defoamers which can be harmful to the foam and/or the process of foam formation. In general, the compositions according to the invention show advantages here in relation to surface qualities, since fewer foam defects arise than with the use of prior art polyether siloxanes.

In a further preferred embodiment, the compositions according to the invention (siloxanes) are used in the continuous production of polyurethane- or polyisocyanurate-based panels having flexible surfacing layers. In this process, the foaming mixture is applied via one or more mix heads to the lower surfacing layer in a double band laminator at band speeds of not more than 45 m/min. In the laminator, the rising mixture then reaches the upper surfacing layer to produce a continuously formed panel which is cut into the desired length at the exit end of the laminator.

A multiplicity of different surfacing layers can be used, examples include paper, aluminium, bitumen, fibrous nonwoven webs, multilayered foils composed of various materials, etc.

Owing to the higher band speeds, the foaming mixture has to spread very uniformly within a short time in order that a homogeneous foam without densifications and irregular cell size distribution may form. Owing to the high discharge quantities which are required here, rigs can also be used which have more than one mix head, in which case the foaming mixture can then be discharged onto the laminator in a plurality of strands. This operation is also referred to as “finger lay down”.

The very different material properties of the surfacing layers represent an additional challenge, since problems can arise depending on the material, for example, defoaming effects due to contamination on the surfacing layers, poor adherence, elevated flow stress in the case of very rough surfaces. The avoidance of surface defects is the primary concern. In general, the compositions according to the invention exhibit advantages here in relation to surface qualities, since fewer foam defects arise than with the use of prior art polyether siloxanes.

The examples which follow describe the present invention by way of example without any intention that the invention, the scope of which is apparent from the entire description and the claims, be restricted to the embodiments mentioned in the examples.

### EXAMPLES

### Example 1

### Preparing Inventive Polyether Siloxanes

The Si—H-functional siloxanes to be used were prepared as in Example 1 of EP 1439200 from the corresponding siloxane raw materials by equilibration (To prepare siloxanes with terminal modification, it is correspondingly necessary to use a polymethylhydrosiloxane with terminal hydrogen functionality as raw material.). Raw material type and quantity was chosen such that the siloxane structure desired in each case was obtained.

The allyl polyethers were prepared similarly to the method described in Example 1 of DE 19940797 although allyl alcohol was used as starter and correspondingly ethylene oxide and propylene oxide or styrene oxide.

The allyl-started polyethers used were etherified (endcapped) by reaction with methyl chloride according to the method described in DE 102005001076.

The hydrosilylation reactions (of the Si—H-functional siloxanes with the allyl polyethers) were carried out in accordance with Example 1 of EP 1 520 870.

Table 2 summarizes the structures used for the modifying R¹ radicals.

Table 3 describes the inventive siloxanes. The designations and indices used in formula (I) were used. All %ages in Table 2 and Table 3 are mol %.

TABLE 2
Description of R¹ side chains

| R¹ | R′ | R″ | R′″ | x | y | z |
|---|---|---|---|---|---|---|
| A | 35% Me; 65% H | H | — | 3 | 23 | 1 |
| B | 38% Me; 68% H | Me | — | 3 | 23 | 1 |
| C | 20% Me; 80% H | Me | — | 3 | 17 | 1 |
| D | 100% H | Me | — | 3 | 13 | 1 |
| E | 25% Me; 75% H | H | — | 3 | 13 | 1 |
| F | 100% H | Me | — | 3 | 10 | 1 |
| G | 20% Me; 80% H | Me | — | 3 | 25 | 1 |
| H | 52% Me; 48% H | Me | — | 3 | 27 | 1 |
| I | 45% Me; 55% H | Me | — | 3 | 29 | 1 |
| K | 13% Me; 87% H | Me | — | 3 | 11.5 | 1 |
| L | 20% Me; 80% H | H | — | 3 | 26 | 1 |
| M | 17% Me; 83% H | Me | — | 3 | 29 | 1 |
| N | | C₁₆H₃₃ | — | 0 | 0 | 0 |
| O | 18% Me; 82% H | (CO)—R″′ | Me | 3 | 24.5 | 1 |
| P | 20% Me; 20% Et; 60% H | Me | — | 3 | 23 | 1 |
| Q | 20% Me; 20% Ph; 60% H | Me | — | 3 | 21 | 1 |

Me = methyl, Et = ethyl, Ph = phenyl

The R¹ side chains described in Table 2 under the designations of A to Q were used as a basis for the preparation of the siloxanes summarized in Table 3.

TABLE 3
Description of siloxanes of formula (I)

| Siloxane | R | R² | R¹ | n | m |
|---|---|---|---|---|---|
| 1 | R¹ | R¹ | 50% A; 50% B | 40 | 4 |
| 2 | R¹ | R¹ | 50% D; 50% E | 40 | 4 |
| 3 | Me | Me | 50% A; 50% G | 25 | 2 |
| 4 | Me | Me | 50% A; 50% B | 20 | 1.5 |
| 5 | R¹ | R¹ | 70% D; 30% E | 20 | 0.5 |
| 6 | R¹ | R¹ | 70% D; 30% L | 42 | 2 |
| 7 | Me | Me | 70% C; 30% E | 52 | 8 |
| 8 | Me | Me | 75% F; 25% L | 55 | 7 |
| 9 | Me | Me | 60% K; 20% H; 20% L | 20 | 3 |
| 10 | Me | Me | 60% I; 20% O; 20% L | 40 | 7 |
| 11 | R¹ | R¹ | 75% M; 25% L | 130 | 10 |
| 12 | R¹ | R¹ | 50% L; 30% G; 20% N | 60 | 8 |
| 13 | Me | Me | 60% O; 20% H; 20% L | 75 | 5 |
| 14 | Me | Me | 50% A; 50% Q | 25 | 2 |
| 15 | R¹ | R¹ | 50% A; 50% P | 25 | 2 |

### Example 2

### Use of Polyether Siloxanes in Foaming

The performance advantages over the prior art which are provided by using the inventive polyether siloxanes in rigid foam formulations will now be demonstrated using (application) examples.

The foaming tests were carried out by hand mixing. For this purpose, polyol, flame retardant, catalysts, water, conventional or inventive foam stabilizer and blowing agent were weighed into a beaker and mixed by means of a disc stirrer (6 cm in diameter) at 1000 rpm for 30 s. The blowing agent quantity which had evaporated during mixing was determined by reweighing and replenished. The MDI was then added, the reaction mixture was stirred with the described stirrer at 3000 rpm for 5 s and immediately transferred into a thermostatted aluminium mold lined with polyethylene film. The mold temperature and geometry varied with the foam formulation. The amount used (based on about 100 g of polyol) of foam formulation was determined such that the foam formed therefrom was 15% above the minimum amount necessary to fill the mold.

One day after foaming, the foams were analyzed. Surface and internal defects were rated subjectively on a scale from 1 to 10, where 10 represents an undisrupted foam and 1 represents a very severely disrupted foam. The pore structure (average number of cells per cm) was assessed visually on a cut surface by comparison with comparative foams. The thermal conductivity coefficient was measured on 2.5 cm thick discs using a Hesto Lambda Control instrument at temperatures of 10° C. and 36° C. for the bottom side and the top side of the sample. The percentage volume fraction of closed cells was determined using an AccuPyc 1330 instrument from Micromeritics, based on the principle of gas displacement. The compressive strengths of the foams were measured on cube-shaped test specimens having an edge length of 5 cm in accordance with DIN 53421 to a compression of 10% (the maximum compressive stress occurring in this measuring range is reported).

### Example 2a

### PUR Rigid Foam System for Insulation of Cooling Appliances

A formulation adapted to this field of use was used (see Table 4), which was separately foamed with inventive polyether siloxane foam stabilizers from Example 1 (designation see Table 3) and two non-inventive polyether siloxane foam stabilizers (Tegostab B 1048, a completely butyl-capped polyether siloxane, and Tegostab B 8408, an uncapped, i.e. exclusively OH-containing, polyether siloxane from Evonik Goldschmidt GmbH). The reaction mixture was introduced into a 145 cm×14.5 cm×3.5 cm aluminium mold thermostatted to 45° C.

TABLE 4
Formulation for refrigerator insulation

| Component | Weight fraction | |
|---|---|---|
| Daltolac R 471* | 100 | parts |
| N,N-dimethylcyclohexylamine | 1.5 | parts |
| water | 2.6 | parts |
| cyclopentane | 13.1 | parts |
| polyether siloxane | 1.5 | parts |
| Desmodur 44V20L** | 198.5 | parts |

*polyether polyol from Huntsman
**polymeric MDI from Bayer, 200 mPa*s, 31.5% by weight NCO, functionality 2.7

The results reported in Table 5 show that the inventive polyether siloxanes consistently provide lower thermal conductivities than the two non-inventive comparative stabilizers. In the case of siloxanes 2, 5, 8 and 9, moreover, the foam surface is less disrupted than in the case of the comparative stabilizers.

TABLE 5
Results for refrigerator insulation

| | | Defects | | | |
|---|---|---|---|---|---|
| | | (1-10) | | | |
| | | top/bottom/ | | λ value/ | Closed cell |
| Test | Siloxane | inside | Cells/cm | mW/m*K | content/% |
| comp. 1 | B 1048* | 7/6/7 | 40-44 | 22.6 | 93 |
| comp. 2 | B 8408* | 7/6/6 | 35-39 | 23.1 | 91 |
| 1 | 1 | 7/8/7 | 40-44 | 22.1 | 94 |
| 2 | 2 | 8/7/8 | 40-44 | 22.0 | 93 |
| 3 | 3 | 7/8/8 | 40-44 | 21.8 | 94 |
| 4 | 5 | 8/7/7 | 40-44 | 21.9 | 92 |
| 5 | 6 | 7/8/9 | 45-50 | 21.8 | 92 |
| 6 | 7 | 7/8/7 | 40-44 | 22.0 | 92 |
| 7 | 8 | 8/7/7 | 40-44 | 22.1 | 94 |
| 8 | 9 | 8/7/7 | 40-44 | 21.9 | 93 |
| 9 | 10 | 7/8/9 | 45-50 | 22.1 | 92 |

*non-inventive, comparative examples; TEGOSTAB B 1048 and TEGOSTAB B 8408 are polyether siloxane foam stabilizers from Evonik Goldschmidt GmbH

### Example 2b

### PUR Rigid Foam System for Metal Composite Elements

A formulation adapted to this field of use was used (see Table 6) and separately foamed with an inventive polyether siloxane foam stabilizer (designation as per Table 3) and two non-inventive polyether siloxane foam stabilizers (Tegostab B 8443, a polyether siloxane with exclusively methyl ether groups, and Tegostab B 8486, a polyether siloxane with exclusively OH groups, both from Evonik Goldschmidt GmbH). The reaction mixture was introduced into a 50 cm×50 cm×5 cm aluminium mold thermostatted to 40° C., which had previously been lined with polyethylene films and into which a steel sheet surfacing layer had then been placed on the bottom thereof. The next day, the metal sheet was pulled off the foam and the foam assessed thereafter. The tests were repeated to produce the photos (FIG. 1 to FIG. 7), except that in place of the 50 cm×50 cm steel sheet surface layer only a 20 cm×5 cm metal strip was used.

TABLE 6
Formulations for metal composite element

| Component | Weight fraction | |
|---|---|---|
| polyether polyol blend | 70 | parts |
| tris(1-chloro-2-propyl) phosphate | 30 | parts |
| N,N,N′,N″,N″-pentamethyldiethylenetriamine | 0.2 | parts |
| N,N-dimethylcyclohexylamine | 2.0 | parts |
| water | 2.5 | parts |
| n-pentane | 6.0 | parts |
| polyether siloxane | 2.0 | parts |
| Desmodur 44V20L** | 140 | parts |

**polymeric MDI from Bayer, 200 mPa*s, 31.5% by weight of NCO, functionality 2.7

The results reported in Table 7 show that the inventive polyether siloxanes again offer lower thermal conductivities than the two non-inventive, comparative stabilizers. After the steel sheet surfacing layer has been peeled off the bottom side of the foam, the foam defects underneath become visible (FIGS. 1 to 7). The inventive polyether siloxanes exhibit a distinct reduction in void formation and therefore offer better surface quality than the comparative products.

TABLE 7
Results for metal composite element

| | | Defects | | | |
|---|---|---|---|---|---|
| | | (1-10) | | | |
| | | top/bottom/ | | λ value/ | Closed cell |
| Test | Siloxane | inside | Cells/cm | mW/m*K | content/% |
| comp. 3 | B 8443* | 7/5**/8 | 45-50 | 22.3 | 94 |
| comp. 4 | B 8486* | 7/4**/7 | 40-44 | 23.0 | 93 |
| 10 | 1 | 7/9**/8 | 45-50 | 21.9 | 94 |
| 11 | 2 | 7/8**/8 | 45-50 | 22.0 | 92 |
| 12 | 3 | 7/8**/7 | 45-50 | 21.8 | 94 |
| 13 | 4 | 8/9**/7 | 45-50 | 21.8 | 94 |
| 14 | 5 | 8/8**/8 | 45-50 | 22.0 | 93 |
| 15 | 6 | 7/8/7 | 45-50 | 21.9 | 94 |
| 16 | 7 | 7/7/8 | 45-50 | 22.1 | 92 |
| 17 | 8 | 7/8/7 | 45-50 | 21.8 | 93 |
| 18 | 9 | 7/7/8 | 45-50 | 21.8 | 94 |
| 19 | 10 | 7/7/7 | 45-50 | 22.0 | 92 |
| 20 | 12 | 7/8/8 | 45-50 | 22.0 | 94 |
| 21 | 14 | 7/8/7 | 45-60 | 21.9 | 93 |
| 22 | 15 | 8/7/7 | 45-50 | 21.9 | 94 |

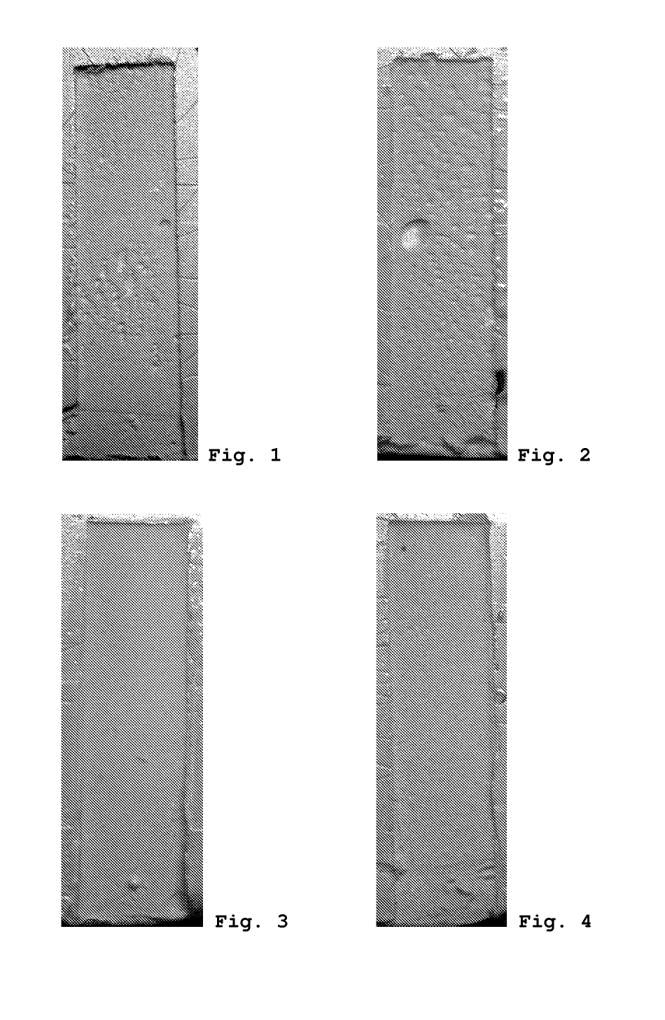

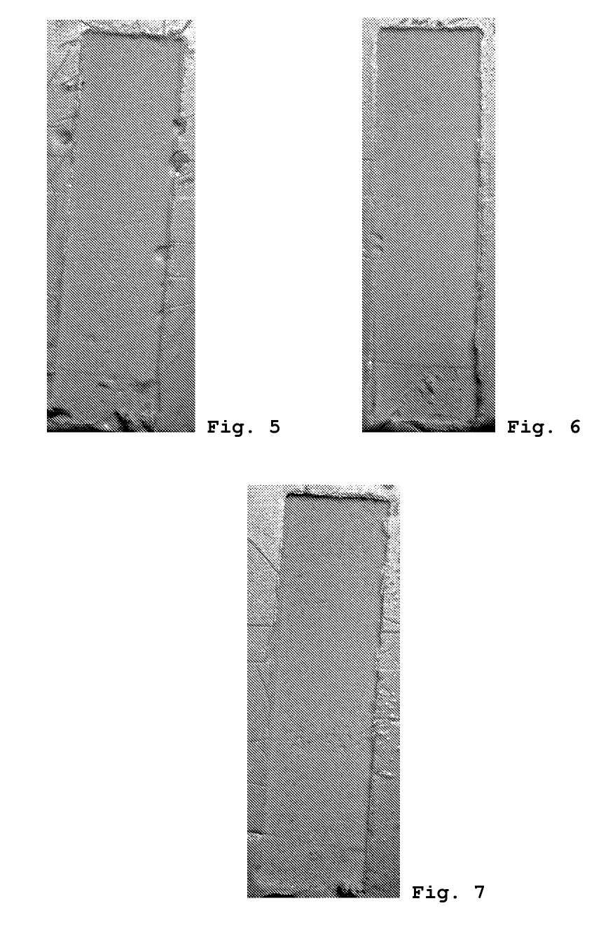

*non-inventive, comparative examples; TEGOSTAB B 8443 and TEGOSTAB B 8486 are polyether siloxane foam stabilizers from Evonik Goldschmidt GmbH
**bottom-side foam quality after removal of metal sheet is shown in FIGS. 1 to 7 (only a 5 cm wide metal strip was pulled off the foams for the photographs). FIG. 1 shows the surface as per comparative example 3, FIG. 2 shows the surface as per comparative example 4, FIG. 3 shows the surface as per test 10, FIG. 4 shows the surface as per test 11, FIG. 5 shows the surface as per test 12, FIG. 6 shows the surface as per test 13 and FIG. 7 shows the surface as per test 14.

### Example 2c

### PIR Rigid Foam System for Insulation Board

A formulation adapted to this field of use was used (see Table 8), and foamed with several inventive polyether siloxane foam stabilizers (designation as per Table 3) and two non-inventive polyether siloxane foam stabilizers (Tegostab B 1048 and Tegostab B 8466, both from Evonik Goldschmidt GmbH). The reaction mixture was introduced into a 50 cm×25 cm×5 cm aluminium mold thermostatted to 50° C.

TABLE 8
Formulations for insulation board

| Component | Weight fraction |
|---|---|
| Stepanpol PS 2352* | 100 parts |
| tris(1-chloro-2-propyl) phosphate | 15 parts |
| N,N,N′,N″,N″-pentamethyldiethylenetriamine | 0.2 parts |
| potassium octoate (75 wt % in diethylene glycol) | 4.0 parts |
| water | 0.4 parts |
| n-pentane | 20 parts |
| polyether siloxane | 2.0 parts |
| Desmodur 44V20L** | 200 parts |

*polyester polyol from Stepan
**polymeric MDI from Bayer, 200 mPa*s, 31.5% by weight of NCO, functionality 2.7

The results reported in Table 9 show once more that the inventive polyether siloxanes provide lower thermal conductivities and better foam quality on the bottom side than the non-inventive, comparative products.

TABLE 9
Results for insulation board

| | | Defects | | | |
|---|---|---|---|---|---|
| | | (1-10) | | | |
| | | top/bottom/ | | λ value/ | Closed cell |
| Test | Siloxane | inside | Cells/cm | mW/m*K | content/% |
| comp. 5 | B 1048* | 6/7/8 | 40-45 | 23.0 | 92 |
| comp. 6 | B 8466* | 6/7/8 | 45-50 | 22.8 | 94 |
| 23 | 1 | 7/8/8 | 45-50 | 22.3 | 93 |
| 24 | 2 | 8/8/8 | 45-50 | 22.5 | 93 |
| 25 | 3 | 7/8/8 | 45-50 | 22.2 | 92 |
| 26 | 4 | 7/8/7 | 45-50 | 22.3 | 94 |
| 27 | 5 | 8/8/8 | 45-50 | 22.4 | 93 |
| 28 | 6 | 8/7/8 | 45-50 | 22.3 | 92 |
| 29 | 9 | 7/8/7 | 45-50 | 22.4 | 94 |
| 30 | 11 | 6/9/7 | 45-50 | 22.5 | 92 |
| 31 | 12 | 7/9/7 | 45-50 | 22.5 | 93 |
| 32 | 13 | 8/8/7 | 45-50 | 22.3 | 92 |
| 33 | 14 | 7/8/7 | 45-50 | 22.5 | 94 |
| 34 | 15 | 8/7/7 | 45-50 | 22.4 | 93 |

*non-inventive, comparative examples; TEGOSTAB B 1048 and TEGOSTAB B 8466 are polyether siloxane foam stabilizers from Evonik Goldschmidt GmbH

While the present disclosure has been particularly shown and described with respect to preferred embodiments thereof, it will be understood by those skilled in the art that the foregoing and other changes in forms and details may be made without departing from the spirit and scope of the present disclosure. It is therefore intended that the present disclosure not be limited to the exact forms and details described and illustrated, but fall within the scope of the appended claims.

What is claimed is:

1. A polyether siloxane of formula (I),
R—Si(CH₃)₂—O—[—Si(CH₃)₂—O—]ₙ—[—Si(CH₃)R¹—O—]ₘ—Si(CH₃)₂—R² (I)
where
R, R¹ and R² are the same or different,
R and/or R² are methyl or R′,
R¹ in each occurrence is the same or different and represents —(CH₂)ₓ—(O)_{z}—(CH₂—CHR′—O)_{y}—R″,
R′ in each occurrence is the same or different and represents —H, —CH₃, —CH₂CH₃ or phenyl,
R″ in each occurrence is the same or different and represents —H, —(CO)—R′″, —(CO)—NH—R′″ or -alkyl,
R′″ in each occurrence is the same or different and represents C₁ to C₄₀-alkyl, -aryl or -alkylaryl,
n+m+2=10 to 85,
m=0 to 20,
x=2 to 15,
y=1 to 40,
z=0 to 1
where the (CH₂—CHR′—O) units can be the same or different,
with the proviso that for m=0 at least one R or R² radical is R¹,
and that for z=0 the requirement is that x and y=0 and R″ contains at least 3 carbon atoms, although z=0 applies to not more than 70 mol % of the R¹ radicals in the siloxane,
or a mixture thereof,
wherein on average (number average, averaged over all compounds of formula (I)) from 10 to 90 mol % of the R″ radicals are not hydrogen radicals, and the remaining proportions of the R″ radicals are hydrogen atoms.

2. The polyether siloxane of claim 1, wherein (n+m)/m is not less than 5.

3. The polyether siloxane of claim 1, wherein on average at least 75 mol % of the R and R² radicals are R¹.

4. The polyether siloxane of claim 1, wherein on average (number average, averaged over all compounds of formula (I)) at least 50 mol % of the R′ radicals are —H.

5. The polyether siloxane of claim 1, wherein on average m=0 to 5, n+m+2=10 to 40, x=3 and y=5 to 25.

6. A composition suitable for producing rigid polyurethane or polyisocyanurate foams, said composition comprising at least one isocyanate component, at least one polyol component, at least one foam stabilizer, at least one urethane and/or isocyanurate catalyst, and water and/or blowing agents, wherein said at least one foam stabilizer includes a polyether siloxane of formula (I),
R—Si(CH₃)₂—O—[—Si(CH₃)₂—O—]ₙ—[—Si(CH₃)R¹—O—]ₘ—Si(CH₃)₂—R² (I)
where
R, R¹ and R² are the same or different,
R and/or R² are methyl or R¹,
R¹ in each occurrence is the same or different and represents —(CH₂)ₓ—(O)_{z}—(CH₂—CHR′—O)_{y}—R″,
R′ in each occurrence is the same or different and represents —H, —CH₃, —CH₂CH₃ or phenyl,
R″ in each occurrence is the same or different and represents —H, —(CO)—R″, —(CO)—NH—R′″ or -alkyl,
R′″ in each occurrence is the same or different and represents C₁ to C₄₀-alkyl, -aryl or -alkylaryl,
n+m+2=10 to 85,
m=0 to 20,
x=2 to 15,
y=1 to 40,
z=0 to 1
where the (CH₂—CHR′—O) units can be the same or different,
with the proviso that for m=0 at least one R or R² radical is R¹,
and that for z=0 the requirement is that x and y=0 and R″ contains at least 3 carbon atoms, although z=0 applies to not more than 70 mol % of the R¹ radicals in the siloxane,
or a mixture thereof,
wherein on average (number average, averaged over all compounds of formula (I)) from 10 to 90 mol % of the R″ radicals are not hydrogen radicals, and the remaining proportions of the R″ radicals are hydrogen atoms.

7. A process for producing a rigid polyurethane or polyisocyanurate foam, comprising reacting at least one isocyanate component, at least one polyol component, at least one foam stabilizer, at least one urethane and/or isocyanurate catalyst, and water and/or blowing agents, wherein said at least one foam stabilizer includes a polyether siloxane of formula (I),
R—Si(CH₃)₂—O—[—Si(CH₃)₂—O—]ₙ—[—Si(CH₃)R¹—O—]ₘ—Si(CH₃)₂—R² (I)
where
R, R¹ and R² are the same or different,
R and/or R² are methyl or R¹,
R¹ in each occurrence is the same or different and represents —(CH₂)ₓ—(O)_{z}—(CH₂—CHR′—O)_{y}—R″,
R′ in each occurrence is the same or different and represents —H, —CH₃, —CH₂CH₃ or phenyl,
R″ in each occurrence is the same or different and represents —H, —(CO)—R′″, —(CO)—NH—R′″ or -alkyl,
R′″ in each occurrence is the same or different and represents C₁ to C₄₀-alkyl, -aryl or -alkylaryl,
n+m+2=10 to 85,
m=0 to 20,
x=2 to 15,
y=1 to 40,
z=0 to 1
where the (CH₂—CHR′—O) units can be the same or different,
with the proviso that for m=0 at least one R or R² radical is R′,
and that for z=0 the requirement is that x and y=0 and R″ contains at least 3 carbon atoms, although z=0 applies to not more than 70 mol % of the R¹ radicals in the siloxane,
or a mixture thereof,
wherein on average (number average, averaged over all compounds of formula (I)) from 10 to 90 mol % of the R″ radicals are not hydrogen radicals, and the remaining proportions of the R″ radicals are hydrogen atoms.

8. The process of claim 7, wherein a composite material, a panel or both are produced.

9. The process of claim 7, further comprising foaming the rigid foam onto a surfacing layer or in-between two surfacing layers.

10. The process of claim 9, wherein the at least one surfacing layer is a metal or plastics surfacing layer.

11. A rigid polyurethane or polyisocyanurate foam formed by the process of claim 7.

12. The rigid polyurethane or polyisocyanurate foam of claim 11, wherein said foam contains from 0.1 to 10 parts by mass of polyether siloxane based on 100 parts by mass of polyol component.

13. The rigid polyurethane or polyisocyanurate foam claim 11 wherein said rigid foam is formed into an insulation board, insulant, or cooling apparatus.
